(19) United States
(12) Patent Application Publication
(10) Pub. No.: US 2007/0128731 A1
(43) Pub. Date: Jun. 7, 2007

(54) Methods for preparing crystalline rapamycin and for measuring crystallinity of rapamycin compounds using differential scanning calorimetry

(75) Inventors: Subodh S. Deshmukh, White Plains, NY (US); Mahmoud Mirmehrabi, Laval (CA)

Correspondence Address: HOWSON AND HOWSON;CATHY A. KODROFF, SUITE 210, 501 OFFICE CENTER DRIVE, FT WASHINGTON, PA, 19034, US

(73) Assignee: Wyeth, Madison, NJ (US)

(21) Appl. No.: 11/634,694

(22) Filed: Dec. 6, 2006

Related U.S. Application Data
(60) Provisional application No. 60/748,005, filed on Dec. 7, 2005.

(51) Int. Cl. G01N 25/20

(52) U.S. Cl. 436/147

(57) ABSTRACT

Methods for purifying rapamycin are described. Methods for measuring particle quality, median particle size, and crystallinity of samples containing rapamycin or a derivative thereof are also provided.

### CROSS-REFERENCE TO RELATED APPLICATIONS

This application claims the benefit of the priority of U.S. Provisional Patent Application No. 60/748,005, filed Dec. 7, 2005.

### BACKGROUND OF THE INVENTION

Methods for preparing crystalline rapamycin compounds and measuring crystallinity and particle quality of samples containing a rapamycin compound are described.

Rapamycin (the Rapamune® drug) is an immunosuppressant derived from nature, which has a novel mechanism of action. CCI-779 (rapamycin 42-ester with 3-hydroxy-2-(hydroxymethyl)-2-methylpropionic acid) is an ester of rapamycin, which has demonstrated significant inhibitory effects on tumor growth in both in vitro and in vivo models.

Numerous routes to rapamycin compounds and purification thereof have been described in the literature, some resulting in rapamycin compounds having acceptable specifications required by regulatory agencies such as the US Food and Drug Administration (FDA). However, samples of rapamycin compounds prepared using these routes may contain crystals of varying quality.

What are needed in the art are methods for preparing crystalline rapamycin and for measuring the crystallinity and particle quality of samples of rapamycin compounds.

### SUMMARY OF THE INVENTION

In one aspect, methods for measuring particle quality of a rapamycin compound are provided.

In another aspect, methods for measuring crystallinity of a rapamycin compound are provided.

In yet a further aspect, methods for preparing crystalline rapamycin are provided.

Other aspects and advantages of the present invention are described further in the following detailed description of the preferred embodiments thereof.

### BRIEF DESCRIPTION OF THE FIGURES

FIG. 1 provides peak temperatures obtained from DSC graphs for twenty-five (25) CCI-779 samples as a function of particle category.. A particle category 1 refers to crystalline CCI-779 samples having large particles; a particle category 2 refers to crystalline CCI-779 samples having small particles; a particle category 3 refers to semi-crystalline CCI-779 aggregates; and particle category 4 refers to non-crystalline CCI-779.

FIGS. 2A and 2B provide DSC graphs noting peak temperatures for five (5) rapamycin samples of varying crystallinity. In FIG. 2A, the top plot corresponds to a sample containing crystalline rapamycin; the middle plot corresponds to a sample containing semi-crystalline rapamycin; and the lower plot corresponds to a sample containing amorphous rapamycin. In FIG. 2B, the top plot corresponds to a sample containing crystalline rapamycin held at 25 to 60° C. for 2 months; the middle plot corresponds to a sample containing crystalline rapamycin held at 25 to 60° C. for 4 months; and the lower plot corresponds to the sample containing crystalline rapamycin identified in FIG. 2A.

FIG. 3 provides a graph illustrating the relationship between the degree of crystallinity and thermal parameters including the heat of fusion (J/g), melting onset temperature (° C.), and peak temperature (° C.) for six (6) CCI-779 samples. Shaded triangles (▴) illustrate the correlation of peak temperature and crystallinity; shaded diamonds (♦) illustrate the correlation of heat of fusion and crystallinity; and shaded squares (▪) illustrate the correlation of onset temperature on crystallinity.

### DETAILED DESCRIPTION OF THE INVENTION

Methods for preparing crystalline rapamycin and measuring samples of rapamycin compounds for particle quality, particle size, and crystallinity are described.

The term “particle quality” as used herein refers to the quality of crystals of a rapamycin compound. Typically, particle quality refers to the majority of crystals in a sample containing a rapamycin compound. Particle quality can be indicative of a variety of factors including the crystal size, the size distribution of the crystals, the chemical homogeneity/purity of the crystals, and the morphology of the majority of the crystals. In one example, a high particle quality may refer to crystals whereby the majority of the crystals in a sample are large. In another example, a high particle quality may refer to a sample whereby the majority of the crystals have the same morphology. In a fuirther example, a high particle quality may refer to a sample whereby the majority of the crystals are not contaminated by impurities. In yet another example, a high particle quality may refer to a sample whereby the majority of the crystals are large, have the same morphology, and are not contaminated by impurities.

The term “crystallinity” as used herein refers to the degree of structural order in a sample containing a rapamycin compound. Typically, crystallinity is represented by a fraction or percentage as a measure of how likely atoms or molecules are to be arranged in a regular pattern such as a crystal. The crystallinity of a rapamycin compound contributes to the overall particle quality and is affected by impurities, such as atoms and molecules or by crystallization conditions or the presence of defects. In one example, a sample having a higher crystallinity will have a powder X-ray diffraction pattern having well-defined peaks. In one example, a sample having a crystallinity of about 0% contains a solid that is substantially amorphous. In another example, a sample having a crystallinity of about 100% contains a solid that is highly crystalline. In a further example, a sample having a crystallinity of about 50% contains a solid that is semi-crystalline.

The term “particle size” as used herein refers to the size of the majority of the crystals in a sample. Typically, “particle size” refers to the median size of the crystals in a sample as determined by measuring the longest linear dimension. The particle size of a rapamycin compound contributes to the overall particle quality.

A. Methods for Preparing Crystalline Rapamycin

In one embodiment, methods for preparing crystalline rapamycin are described. These methods are especially useful for large scale preparations and provide highly crystalline rapamycin. These methods are also advantageous since the crystalline rapamycin prepared thereby is more stable, thereby resulting in the presence of fewer oxidative and/or hydrolysis degradation impurities. The term “oxidative” or “hydrolysis” degradation impurities refers to impurities formed by oxidation and/or hydrolysis of the triene region of the rapamycin molecule.

The term “rapamycin” is a term utilized in the art and herein to describe the following compound.

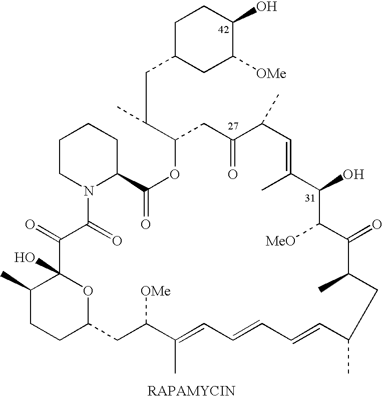

The term “crude rapamycin” as used herein refers to a rapamycin sample that is substantially crystalline, but contains less than about 20% impurities. In one example, crude rapamycin contains less than about 15% impurities. In another example, crude rapamycin contains less than about 10% impurities. In a further example, crude rapamycin contains less than about 5% impurities. There are a variety of methods for preparing crude rapamycin and include U.S. Pat. No. 3,993,749, which is hereby incorporated by reference. Alternatively, rapamycin can be purchased commercially (e.g., Wyeth). The crude rapamycin can be non-micronized or micronized as described in U.S. Pat. No. 5,985,325, which is hereby incorporated by reference.

The first step of this method includes heating crude rapamycin in ethyl acetate to an elevated temperature. In one embodiment, the rapamycin/ethyl acetate solution is heated to about 52 to about 58° C. In another embodiment, the rapamycin/ethyl acetate solution is heated to about 55° C. Thereafter, the heated, ethyl acetate solution is filtered. A variety of filtration instruments may be utilized and are readily understood by one of skill in the art. The filtered solution is then maintained at an elevated temperature. In one embodiment, the rapamycin/ethyl acetate solution is maintained at a temperature of about 50 to about 60° C. In another embodiment, the rapamycin/ethyl acetate solution is maintained at a temperature of about 54° C. to about 57° C.

A solvent containing a hydrocarbon solvent is then added to the heated solution. In one embodiment, the hydrocarbon solvent is heptanes. In another embodiment, the hydrocarbon solvent is hexanes. In a further embodiment, the hydrocarbon solvent is pentanes. The hydrocarbon solvent is desirably added at a rate that results in the formation of crystalline rapamycin, desirably by gradual crystallization. The hydrocarbon solvent may therefore be added at a constant rate or a non-linear rate. Suitably, the rate of hydrocarbon solvent addition maintains the temperature of the heated solution. More suitably, the addition rate of the hydrocarbon solvent maintains the temperature at about 54 to 57° C. One of skill in the art would readily be able to adjust the hydrocarbon solvent rate of addition to avoid premature precipitation of the rapamycin.

The hydrocarbon solvent is therefore typically added over a period of at least about 20 minutes. In one example, the hydrocarbon solvent is added over a period of at least about 30 minutes. In another example the, hydrocarbon solvent is added over a period of about 60 minutes. In a further example, the hydrocarbon solvent is added over a period of about 60 minutes at a constant rate. One of skill in the art would readily be able to adjust the period of time required to add the hydrocarbon solvent to avoid premature precipitation of the rapamycin.

The temperature of the ethyl acetate/hydrocarbon solvent solution is then maintained at the elevated temperature. In one example, the ethyl acetate/hydrocarbon solvent solution is maintained for about 30 minutes at a temperature of about 55 to about 57° C. The agitation speed is then reduced to the minimum rate than is required to achieve a solid suspension. One of skill in the art would readily be able to adjust the agitation rate based on the teachings provided herein, the specific reactor being utilized and specifically the power per volume of the reactor. In one example, the agitation rate is reduced to equal to or less than about 100 revolutions per minute (RPM). In another example, the agitation rate is about 45 to about 100 RPM.

After reducing the agitation rate, the solution is cooled in a non-linear fashion at a decreasing cooling rate. In one example, the solution is cooled to about a first reduced temperature using a first cooling rate; cooled to a second reduced temperature using a second cooling rate; and further cooled using a third reduced temperature at a third cooling rate. Typically, the third reduced temperature is less than the second reduced temperature, which is less than the first reduced temperature. In one example, the first reduced temperature is about 38 to about 42° C.; the second reduced temperature is about 23 to about 27° C.; and the third reduced temperature is about 5 to about 10° C. In another example, the first reduced temperature is about 40° C.; the second reduced temperature is about 25° C.; and the third reduced temperature is about 9° C. Typically, the third cooling rate is rate is faster than the second cooling rate, which is faster than the first cooling rate. In one example, the first cooling rate is about 4 to about 7° C./hour; the second cooling rate is about 5 to about 9° C./hour; and the third cooling rate is about 7 to 10° C. In a further example, the first cooling rate is about 5° C./hour; the second cooling rate is about 7.5° C./hour; and the third cooling rate is about 9° C. In one embodiment, the solution is cooled to about 40° C. at a rate of about 5° C./hour; further cooled to a temperature of about 25° C. at a rate of about 7.5° C./hour; and even further cooled to a temperature of about 7 to 8° C. at a rate of at least about 9° C./hour. This solution is then maintained at this temperature for about 2 to about 6 hours. In one example, the solution is maintained at this temperature for about 2 hours.

The inventors also found that the rate of addition of the hydrocarbon solvent influenced the crystallinity of the rapamycin. For example, when heptane is added at a rate of 60 minutes or less, the morphology of the resulting crystals is orthorhombic. However, when heptane is added over a period of at least about 60 minutes, the morphology of the resulting crystals is acicular. However, the slower cooling rate, desirably in a non-linear fashion, following heptane addition resulted in crystals with more uniform size distribution. By controlling these parameters, precipitation of fine particles of rapamycin is more easily controlled and/or avoided, thereby resulting in crystalline rapamycin with a uniform size distribution.

The resultant crystalline rapamycin is then collected via filtration. Further washing of the rapamycin with a solution containing ethyl acetate and the hydrocarbon solvent, desirably heptanes, and drying the crystalline rapamycin is then performed. Desirably, an excess of the hydrocarbon solvent over the ethyl acetate is utilized. In one example, a 2:1 ratio of hydrocarbon solvent /ethyl acetate is utilized. In another example, a 2:1 ratio of heptanes/ethyl acetate is utilized.

The rapamycin is washed using a hydrocarbon solvent/ethyl acetate solution at reduced temperatures. In one example, the rapamycin is washed at a temperature of about 6 to about 10° C. In another example, the rapamycin is washed at a temperature of about 8° C. Typically, the rapamycin is dried in a low-shear dryer, but other drying techniques can be utilized as determined by one of skill in the art.

By preparing the crystallized rapamycin according to the method described herein, crystallized rapamycin is obtained in which the crystallinity is substantially maintained over a period up to 4 months at up to about 60% relative humidity. In one example, the crystallinity is maintained over a period of about 2 months. In another example, the crystallinity is maintained over a period of about 4 months. In a further example, the crystallinity is maintained up to about 60% relative humidity. Specifically, the DSC profiles for the crystalline rapamycin prepared as described herein stored for up to 4 months at up to about 60% relative humidity showed a minimal change in the melting endotherm. In one example, the DSC profile for the crystalline rapamycin showed a change in the melting endotherm of less than about 1%. In one example, the DSC melting endotherm showed a change of less than about 0.5%. In another example, the DSC melting endotherm showed a change of less than about 0.3%. In a further example, the DSC melting endotherm showed a change of less than about 0.1%.

In one embodiment, a method for purifying rapamycin is provided and includes (i) heating crude rapamycin in ethyl acetate to about 55° C.; (ii) filtering the product of step (i); (iii) maintaining the temperature of step (ii) at about 54° C. to about 57° C.; (iv) adding heptanes to the product of step (iii) over a period of about 60 minutes at a constant rate; (v) maintaining the product of step (iv) at the same temperature for about 30 minutes; (vi) reducing the agitation speed of step (v); (vii) cooling the product of step (vi) to about 40° C. at a rate of about 5° C./hour; (viii) cooling the product of step (vii) to a temperature of about 25° C. at a rate of about 7.5° C./hour; (ix) cooling the product of step (viii) to a temperature of about 7 to 8° C. at a rate of at least about 9° C./hour; (x) maintaining the product of step (ix) at the same temperature for about 2 hours; and (xi) filtering the product of step (x) to obtain crystalline rapamycin.

In a further embodiment, a method for purifying rapamycin is provided and includes (i) heating crude rapamycin in ethyl acetate to about 55° C.; (ii) filtering the product of step (i); (iii) maintaining the temperature of step (ii) at about 54° C. to about 57° C.; (iv) adding heptanes to the product of step (iii) over a period of about 60 minutes at a constant rate; (v) maintaining the product of step (iv) at this temperature for about 30 minutes; (vi) reducing the agitation speed of step (v); (vii) cooling the product of step (vi) to about 40° C. at a rate of about 5° C./hour; (viii) cooling the product of step (vii) to a temperature of about 25° C. at a rate of about 7.5° C./hour; (ix) cooling the product of step (viii) to a temperature of about 7 to 8° C. at a rate of at least about 9° C./hour; (x) maintaining the product of step (ix) at this temperature for about 2 hours; (xi) filtering the product of step (x) to obtain crystalline rapamycin; (xii) washing the crystalline rapamycin with ethyl acetate and heptane at about 8° C.; and (xiii) drying the product of step (xii).

B. Methods for Analyzing Rapamycin Compounds

Methods for analyzing rapamycin compounds are also described and are typically performed using differential scanning calorimetry (DSC). Other techniques can be utilized in conjunction with DSC and include X-ray diffraction (XRD) and Raman spectroscopy, without limitation. A variety of DSC instruments is known in the art and can be utilized. In one embodiment, the DSC instrument is the Q1000™ (TA Instruments) DSC instrument, among others.

The term “rapamycin compound” defines a class of immunosuppressive compounds which contain the basic rapamycin nucleus shown above. The rapamycin compounds of this invention include compounds which may be chemically or biologically modified as derivatives of the rapamycin nucleus, while still retaining immunosuppressive properties. Accordingly, the term “rapamycin compound” includes esters, ethers, oximes, hydrazones, and hydroxylamines of rapamycin, as well as rapamycins in which functional groups on the rapamycin nucleus have been modified, for example through reduction or oxidation. The term “rapamycin compound” also includes pharmaceutically acceptable salts of rapamycins, which are capable of forming such salts, either by virtue of containing an acidic or basic moiety. Examples of rapamycin compounds that can be analyzed as described herein include, without limitation, rapamycin, 42-esters of rapamycin including CCI-779 (temsirolimus), norrapamycin, deoxorapamycin, desmethylrapamycins, or desmethoxyrapamycin, or pharmaceutically acceptable salts, prodrugs, or metabolites thereof and those described in US Patent Application Publication Nos. US-2005-0272702, US-2006-013550, US-2006-0040971, US-2006-0036091, US-2005-0014777, US-2006-0199834, US-2005-0234086, and US-2003-0114477 and U.S. Pat. Nos. 5,358,908; 5,358,909; 5,362,718; 5,302,584, which are hereby incorporated by reference. In one example, a rapamycin compound includes rapamycin which can be purchased commercially or can be prepared using a variety of methods available in the art. In another example, a rapamycin compound includes CCI-779.

The term “CCI-779” as used herein refers to rapamycin 42-ester with 3-hydroxy-2-(hydroxymethyl)-2-methylpropionic acid. A variety of methods for preparing CCI-779 is known in the art and includes those described in U.S. Pat. Nos. 5,362,718 and 6,277,983, which are hereby incorporated by reference. Alternatively, CCI-779 can be purchased commercially (e.g., Wyeth). The CCI-779 can be non-micronized or micronized, as described in US Patent Application Publication No. US-2005-0152983-A1, which is hereby incorporated by reference.

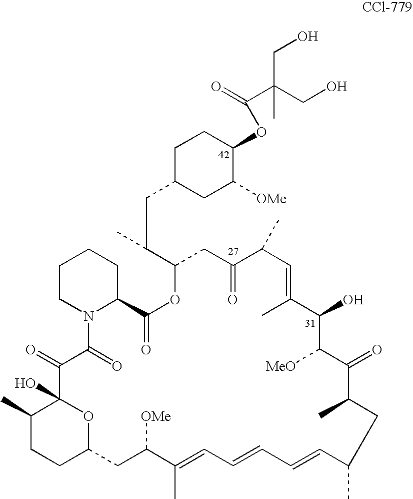

The term “desmethylrapamycin” refers to the class of rapamycin compounds which lack one or more methyl groups. Examples of desmethylrapamycins that can be used according to the present invention include 3-desmethylrapamycin (U.S. Pat. No. 6,358,969), 7-O-desmethyl-rapamycin (U.S. Pat. No. 6,399,626), 17-desmethylrapamycin (U.S. Pat. No. 6,670,168), and 32-O-desmethylrapamycin, among others.

The term “desmethoxyrapamycin” refers to the class of rapamycin compounds which lack one or more methoxy groups and includes, without limitation, 32-desmethoxyrapamycin.

The rapamycin compounds measured in the methods described herein include samples in the solid state and can be crystalline, semi-crystalline, non-crystalline, or aggregates. Crystalline rapamycin is desirably prepared according to the procedures discussed in Sehgal et al., J. Antibiotics, 28(10): 727-732 (1975); Swindells et al., Canadian J. Chem., 56(18):2491-2492 (1978); and US Patent Application Publication No. US-2006-040971. Crystalline CCI-779 is desirably prepared by recrystallization from diethylether and heptane as described in U.S. Provisional Patent Application No. 60/748,006, which is hereby incorporated by reference.

The samples containing rapamycin compounds may contain low levels of impurities, including oxidative and/or hydrolysis impurities, solvents, or the like. In one example, the samples of CCI-779 contain only trace amounts of acetone, desirably less than about 0.3% wt/wt of acetone. Similarly, the samples of CCI-779 contain less than about 0.3% wt/wt phenylboronic acid, and less than about 1.5 wt % of oxidative/hydrolysis decomposition products of CCI-779.

The term “crystalline” as used herein refers to solid samples of rapamycin compounds that have one definitive crystalline structure. The term “semi-crystalline” as used herein refers to solid samples of rapamycin compounds that have crystalline regions dispersed within amorphous regions. The term “non-crystalline” and “amorphous” are used interchangeably and refer to solid samples of rapamycin compounds that have no regions of crystallinity dispersed therethrough and therefore no crystalline form. The term “aggregate” as used herein refers to grouping of crystals which are intergrown or fused in a particle of a rapamycin compound.

Crystal quality is known to influence the stability of a sample containing a rapamycin compound. For example, amorphous or semi-crystalline rapamycin compounds undergo rapid oxidative degradation. Further, the median particle size of rapamycin compounds determines flow property, with a larger particle size being desired. The method thereby includes determining/calculating the particle quality, crystallinity, particle size, or a combination thereof of a sample containing a rapamycin compound, i.e., the test sample. The method is thereby performed by analyzing the DSC heat flow signal of the rapamycin compound. The heat flow signal of the rapamycin compound is then compared to the heat flow signal of a predetermined standard.

A number of useful parameters can be obtained from the heat flow signal and include melting temperature, including onset melting temperature and peak temperature, and heat of fusion. These parameters can also be utilized in the determination of particle quality, crystallinity, or particle size.

The term “melting temperature” as used herein includes the temperature at which a solid, i.e., a rapamycin compound, melts. The melting temperature can include the onset melting temperature or the peak melting temperature. Typically, the melting temperature is the peak melting temperature.

The term “heat of fusion” as used herein describes the total heat released by a rapamycin compound during melting or fusion. The heat of fusion is obtained by integrating the area under the heat flow signal plot and is typically expressed in calories/gram or Joules/gram. However, other conventions for expressing the units of heat of fusion could be utilized by one of skill in the art.

Desirably, the DSC peak temperature, i.e., the melting temperatures, of the heat flow signal of the rapamycin compound is measured and then compared to the heat flow signal of the predetermined standard.

As used herein, the term “predetermined standard” refers to one or more solid samples of a highly crystalline rapamycin compound where the average size of the particles and crystallinity is known and is correlated with a DSC peak temperature. More desirably, the predetermined standard contains crystalline rapamycin compound. Most desirably, the predetermined standard contains a 100% crystalline rapamycin compound.

The heat flow signal of the rapamycin compound can be compared with the heat flow signal of the predetermined standard by a single point correlation or using a calibration curve. By doing so, the crystallinity, particle quality, or particle size of the rapamycin compound being analyzed can be determined.

In one embodiment, the heat flow signal of the test sample containing the rapamycin compound is compared with the heat flow signal of the predetermined standard containing crystalline rapamycin compound using a single point correlation. Typically, the heat of fusion obtained from the heat flow signal is utilized for the comparison. In one example, the heat of fusion is utilized in a single point correlation to determine the crystallinity of a rapamycin compound. In another example, the crystallinity of a rapamycin compound is calculated using a single point correlation.

In a further example, the crystallinity of the rapamycin compound can be calculated using the following equation:

$$test sample crystallinity = \frac{100 \times heat of fusion of the test sample}{heat of fusion of the predetermined standard} .$$

In another embodiment, the heat flow signal of the test sample containing the rapamycin compound is compared with the heat flow signal of the predetermined standard containing crystalline rapamycin compound using a calibration curve. One of skill in the art would readily be able to prepare a calibration curve using the teachings of the specification and knowledge in the art. Typically, the calibration curve is prepared for the predetermined standard by using multiple samples containing crystalline rapamycin compounds. Desirably, at least 3 samples are required to generate the calibration curve. However, more samples can be used as determined by one of skill in the art to prepare the calibration curve. In one example, the heat of fusion of a test sample containing a rapamycin compound is utilized in combination with a calibration curve to determine the crystallinity of the rapamycin compound.

The calibration curve is prepared by plotting the heat of fusion, peak temperature, or onset temperature for each of the multiple samples against the crystallinity of each of the same multiple samples to obtain the calibration curve. A best fit line or curve is then drawn and the formula of the best fit line is calculated. In another example, the calibration curve is prepared by plotting the heat of fusion against the crystallinity. In a further example, the calibration curve is prepared by plotting the peak temperature against the crystallinity. In still a further example, the calibration curve is prepared by plotting the onset temperature against the crystallinity. In yet another example, the calibration curve is calculated by plotting the heat of fusion for each of multiple samples containing a crystalline rapamycin compound of a known crystallinity against the crystallinity for each of multiple samples containing the rapamycin compound. Typically, the calibration curve is specific to the type of DSC instrument and experimental conditions and procedure utilized to obtain the heat of fusion values. However, one of skill in the art would be able to determine if a calibration curve obtained from one procedure and DSC instrument can be utilized by using data obtained from another DSC instrument using the same procedure.

Once the calibration curve is prepared, it can then be utilized to determine the crystallinity of test samples containing a rapamycin compound. Specifically, the test samples containing a rapamycin compound are analyzed to determine one or more of the heat of fusion, peak temperature, or onset temperature of the rapamycin compound in the test sample. These values, i.e., heat of fusion, peak temperature, or onset temperature, can then be utilized using the formula of the best fit line of the predetermined standard to determine the crystallinity, among other factors, of the rapamycin compound in the test sample. By doing so, an accurate determination of the crystallinity of samples containing rapamycin compounds can be obtained.

The inventors have found a trend in the DSC heat flow signal, and thereby the melting temperature, for rapamycin compound samples. Specifically, the heat flow signal of samples containing a rapamycin compound is found to vary depending on the crystallinity of the rapamycin compound. In one example, the crystallinity of the rapamycin compound sample is proportional to the melting temperature of the heat flow signal.

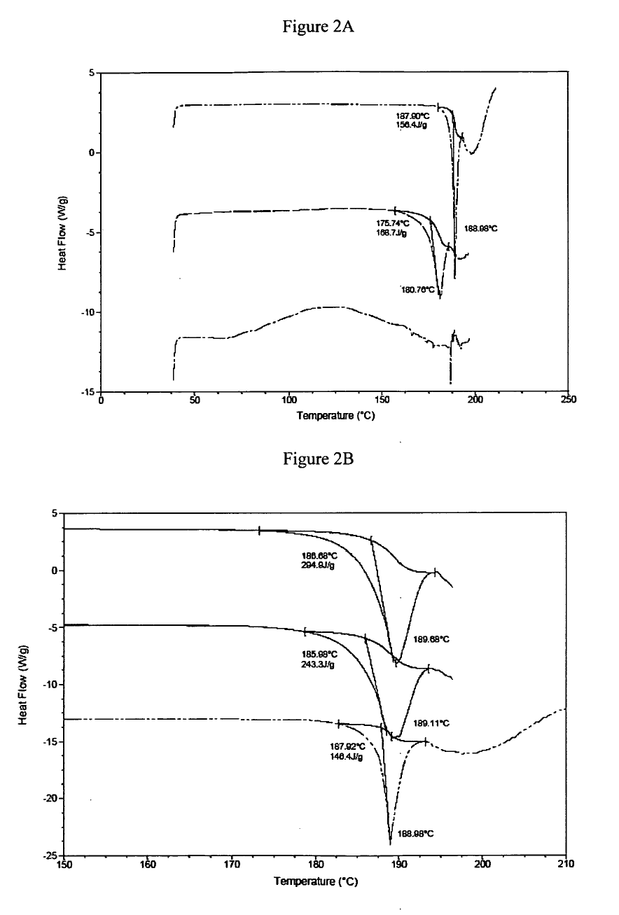

In one embodiment, samples containing higher crystalline rapamycin had large particles and higher melting temperatures of at least about 188° C., desirably about 188° C. to about 190° C. Samples containing less crystalline rapamycin had smaller particles and lower melting temperatures of less than about 183° C., desirably less than about 180 to less than about 183° C. See, FIG. 2.

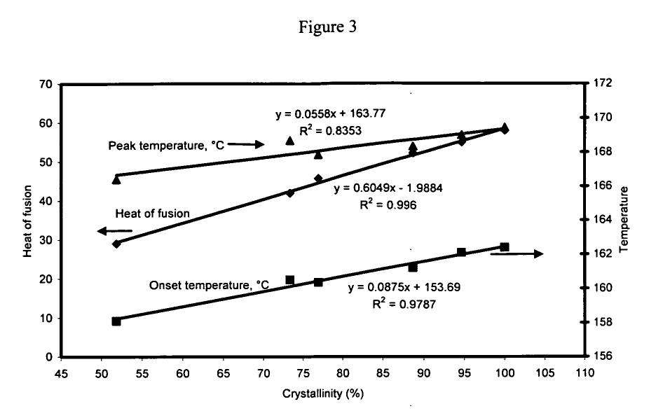

In another embodiment, samples containing higher crystalline CCI-779 had large particles and higher melting temperatures of at least about 168° C., desirably about 168 to about 170° C. Samples containing less crystalline CCI-779 had smaller particles, lower melting temperatures of at least about 166 to less than about 168° C. Samples containing semi-crystalline CCI-779 aggregates had lower melting temperatures than crystalline samples, i.e., melting temperatures of at least about 164° C. to less about 166° C. Further, samples containing non-crystalline CCI-779 had glass transition temperatures, but did not have melting temperatures. See, FIG. 3.

As noted above, the DSC melting temperature is proportional to the size and crystallinity of the rapamycin compound particles. For samples containing CCI-779, a large particle size includes particles that have a median particle size of greater than about 30 μm in length for the longest axis of the particle, and more desirably about 30 μm to about 250 μm for the longest axis of the CCI-779 particle. Alternatively, a small particle size includes particles that have a median particle size of less than about 30 μm for the longest axis of the CCI-779 particle.

The inventors also found that the X-ray diffraction pattern of a less crystalline rapamycin compound contained broad peaks. Further, when samples containing amorphous and crystalline rapamycin compounds are analyzed by XRD, the XRD pattern showed sharp peaks of the crystalline rapamycin compound and a baseline shift or “amorphous halo” for the amorphous rapamycin compound.

In one embodiment, a method is described for measuring particle quality of a rapamycin compound using differential scanning calorimetry, including analyzing the heat flow signal of a sample containing a rapamycin compound; and comparing the heat flow signal to a predetermined standard, wherein the particle quality is proportional to the melting temperature of the sample.

In another embodiment, a method is described for determining particle size of a rapamycin compound using differential scanning calorimetry, including analyzing the heat flow signal of a sample containing a rapamycin compound and comparing the heat flow signal to a predetermined standard, wherein the particle size is proportional to the melting temperature of the sample.

In a further embodiment, a method is provided for determining particle quality of a rapamycin compound using differential scanning calorimetry, including analyzing the heat flow signal of a sample containing a rapamycin compound and comparing the heat flow signal to a predetermined standard, wherein a large particle size of a rapamycin compound is characterized by a high melting temperature and a small particle size is characterized to a low melting temperature.

The following examples are provided to illustrate the invention and do not limit the scope thereof. One skilled in the art will appreciate that although specific reagents and conditions are outlined in the following examples, modifications can be made which are meant to be encompassed by the spirit and scope of the invention.

### EXAMPLES

### Example 1

### General Process for Analyzing Particles of CCI-779 Samples

In this example, DSC peak temperatures were measured and utilized to assess the particle categories for test samples containing CCI-779.

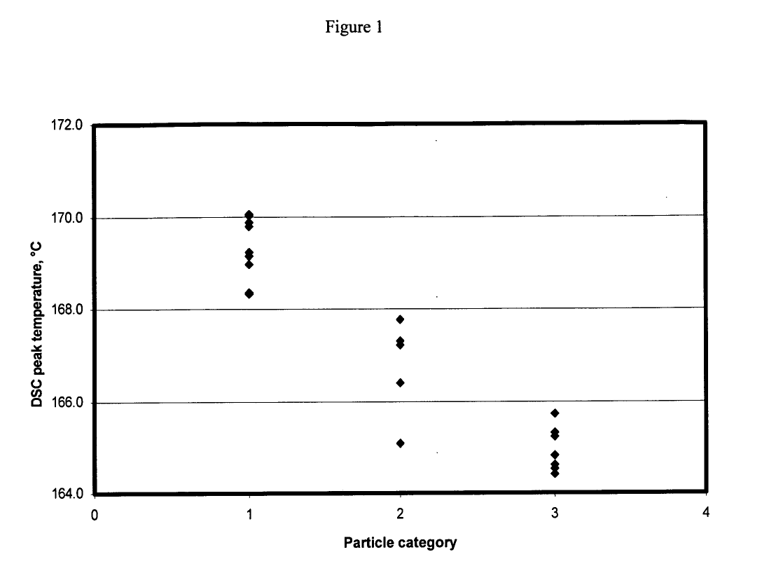

Samples containing CCI-779, obtained by crystallizing CCI-779 from ether/heptane using the procedure set forth in U.S. Provisional Patent Application No. 60/748,006 were analyzed using the Q Series™ Q1000-0450 DSC Instrument (TA Instruments) using the parameters in Table 1. Once the DSC peak temperatures were obtained, they were compared with predetermined standards containing crystalline CCI-779 and placed into particle categories. See, FIG. 1 in which the peak temperatures for the 25 samples were grouped according to particle category. Because there was overlap in the peak temperatures for certain samples, 25 distinct samples are not visible. A particle category 1 refers to crystalline CCI-779 samples having large particles; a particle category 2 refers to crystalline CCI-779 samples having small particles; a particle category 3 refers to semi-crystalline CCI-779 aggregates; and particle category 4 refers to non-crystalline CCI-779.

TABLE 1
DSC Parameters

| | | |
|---|---|---|
| Ramp | 10° | C./min |
| Temperature range | 10 to 200° | C. |
| Equilibration T | 35.00° | C. |
| Data Sampling Interval | 0.50 | sec/point |
| Load Temperature Range | 35.00°C. to 45.00° | C. |
| Unload Temperature Range | 35.00 to 45.00° | C. |
| Delay Time | 0.00 | min |

From this data, it is determined that higher DSC peak temperatures are indicative of CCI-779 samples that are more crystalline.

### Example 2

### Analyzing Particles of CCI-779 Samples

In this example, the particle quality, crystallinity, and melting temperature were measured of twenty five (25) samples of CCI-779 obtained by crystallizing CCI-779 from ether/heptane using the procedure set forth in U.S. Provisional Patent Application No. 60/748,006. The solid samples were analyzed for the DSC peak temperatures using the Q Series™ Q1000-0450 DSC Instrument (TA Instruments) using the parameters in Table 1 as noted above.

The grade and crystallinity size of the sample was then analyzed by optical microscopy. In summary, optical microscopy was performed using a Nikon™ Eclipse E600 microscope capable of 5× to 100× magnification, fitted with a Nikon™ DXM 1200 digital camera and a Nikon™ ACT-1 v 2.12 calibrated image acquisition system. Measurements were obtained by dispersing about 0.05 mg of the sample on a glass holder. The sample was then covered with a drop of Resolve® microscope immersion oil (Richard-Allan Scientific) and a cover slip was added. Care was taken to ensure that the particles were not subjected to attrition during image acquisition. Sample images were acquired about 1 to about 2 minutes after sample preparation. Fresh samples were prepared, if re-imaging was required.

The “class” of the sample was determined by correlating the DSC temperature with the “grade” and “crystallinity size” of the sample. Specifically, if a sample containing CCI-779 was determined to be crystalline by optical microscopy with large crystals, it was assigned a class 1 sample; if a sample containing CCI-779 was determined by optical microscopy to be crystalline with small crystals, it was assigned a class 2 sample; and if a sample containing CCI-779 was determined by optical microscopy to be semi-crystalline, regardless of crystal size, it was assigned a class 3 sample. The class of the sample was then correlated to the DSC peak temperature obtained for the same sample.

TABLE 2

| | | Crystallinity | | DSC Peak T |
|---|---|---|---|---|
| Run | Grade | Size | Class | (° C.) |
| 1 | Crystalline | large | 1 | 168.3 |
| 2 | semi-crystalline | small | 3 | 165.2 |
| 3 | semi-crystalline | small | 3 | 165.7 |
| 4 | Crystalline | small | 2 | 167.8 |
| 5 | Crystalline | large | 1 | 169.8 |
| 6 | semi-crystalline | small | 3 | 164.5 |
| 7 | semi-crystalline | small | 3 | 164.8 |
| 8 | Crystalline | large | 1 | 168.3 |
| 9 | Crystalline | large | 1 | 169.2 |
| 10 | semi-crystalline | small | 3 | 164.4 |
| 11 | Crystalline | small | 2 | 167.3 |
| 12 | Crystalline | small | 2 | 166.4 |
| 13 | Crystalline | large | 1 | 170.0 |
| 14 | Crystalline | large | 1 | * |
| 15 | Crystalline | large | 1 | * |
| 16 | Crystalline | large | 1 | 169.2 |
| 17 | Crystalline | large | 1 | * |
| 18 | Crystalline | large | 1 | 170.1 |
| 19 | Crystalline | small | 2 | 165.1 |
| 20 | Crystalline | large | 2 | 167.2 |
| 21 | semi-crystalline | small | 3 | 164.6 |
| 22 | Crystalline | large | 1 | 169.9 |
| 23 | semi-crystalline | small | 3 | 165.3 |
| 24 | Crystalline | large & small | 1 | 168.4 |
| 25 | Crystalline | large & small | 1 | 169.0 |

* A DSC peak temperature was not obtained for these samples

These results illustrate that, in general, crystalline samples of CCI-779 had higher DSC peak temperatures than semi-crystalline samples of CCI-779. Further, CCI-779 samples containing larger crystals resulted in higher DSC peak temperatures than samples of CCI-779 containing smaller crystals.

### Example 3

### Crystallization of Rapamycin

Crude rapamycin is slurried in ethyl acetate and heating to 55° C. The heated solution is then filtered using a clarifying filter into a crystallizing vessel and the solution is then maintained at 54 to 57° C. Heptanes are then added to the vessel over a period of 60 minutes at a constant rate. After addition of heptanes, the solution is held at 55 to 57° C. for 30 minutes. The agitation speed is then reduced in an effort to achieve a solid suspension. The solution is then cooled to 40° C. over a period of 3 hours at a rate of 5° C./hour; then cooled to 25° C. over a period of 2 hours at a rate of 7.5° C./hour; and further cooled to 7 to 8° C. over a period of at least 60 minutes, desirably over a period of 2 hours at a rate of 9° C. The solution is then held at 7 to 8° C. for 2 hours and then filtered. The solid obtained from the filtration is then washed using a solution containing ethyl acetate/heptanes held at 8° C. The washed solid is then dried using a low-shear dryer to obtain crystalline rapamycin.

### Example 4

### Analyzing the Crystallinity of Samples Containing Varying Content of Crystalline Rapamycin

In this example, samples containing rapamycin (Table 3) were analyzed by DSC and optical microscopy. The morphology and approximate particle size were determined using optical microscopy. A standard DSC sample ramp rate of 10° C./min and a hermetically sealed aluminum pan were utilized. The DSC graphs were obtained and are provided in FIGS. 2A and 2B.

Sample 1 contained crystalline rapamycin and was prepared by suspending crude crystalline rapamycin (1 g) in 10 mL of methoxy-2-propanol and heating the suspension to 40° C. to obtain a clear solution. The solution was cooled from 40° C. to 15° C. over a period of 2 hours and resulted in the gradual crystallization of rapamycin. The crystallized solid was collected via filtration at room temperature and dried in air at room temperature.

Sample 2 contained crystalline rapamycin and about 2 to about 3% of oxidative/hydrolysis degradation impurities and was prepared using the process of Example 3. A portion of the batch was maintained at 25° C. and 60% relative humidity for 2 months.

Sample 3 contains crystalline rapamycin and about 2 to about 3% of oxidative/hydrolysis degradation impurities and was prepared using the process of example 3. A portion of the batch was subjected to 25° C. and 60% relative humidity for 4 months.

TABLE 3

| | | DSC Peak |
|---|---|---|
| Sample | Crystallinity | Temperature (° C.) |
| 1 | Highly crystalline | 188 |
| 2 | crystalline with about 2-3% | 189.7 |
| | of impurities | |
| 3 | crystalline with about 2-3% | 189.1 |
| | of impurities | |

These results illustrate that low levels of impurities in samples containing crystalline rapamycin do not affect the DSC melting temperature of a crystalline rapamycin sample over time.

### Example 5

### Calculating a Calibration Curve to Determine the Correlation Between Heat of Fusion and Crystallinity

This example was performed to prepare a calibration curve to establish the correlation of the heat of fusion with crystallinity. Samples containing known crystalline CCI-779, i.e., a predetermined standard, were analyzed using DSC and the parameters noted in Table 1. Each sample contained a known percentage of crystalline and amorphous CCI-779. The results are provided in Table 4.

TABLE 4

| | Total | Weight Per- | | | |
|---|---|---|---|---|---|
| Amount of | Weight of | centage of | Onset | Peak | Heat of |
| Crystalline | Sample | Crystalline | T | T | Fusion |
| CCI-779 (mg) | (mg) | CCI-779 (%) | (° C.) | (° C.) | (J/g) |
| 4.7 | 5.3 | 88.7 | 161.2 | 168.33 | 52.15 |
| 7.1 | 7.5 | 94.7 | 162.1 | 169 | 64.96 |
| 4 | 5.2 | 76.9 | 160.35 | 167.85 | 45.69 |
| 1.4 | 2.7 | 51.9 | 158.1 | 166.41 | 29 |
| 5.5 | 7.5 | 73.3 | 160.5 | 168.68 | 41.91 |
| 8.3 | 8.3 | 100 | 162.4 | 167.44 | 58.01 |

The crystallinity was then plotted against each of the heat of fusion, onset and peak temperatures. See, FIG. 3.

The graph illustrates that all three parameters linearly correlated with the amount of crystalline CCI-779 in the samples. The graph also illustrates that the best linear correlation is achieved using the heat of fusion. Not only was the correlation error of the heat of fusion measurement lower than the other two parameters, but it also had a higher sensitivity. The higher sensitivity was determined by monitoring the slope of the line, which slope is about twice (006049) the slope of the onset temperature (0.0875).

Specifically, by using the heat of fusion obtained for each sample and the degree of crystallinity, a relationship between the crystallinity and heat of fusion was determined for this particular instrument as illustrated by the following equation.
Degree of crystallinity=1.6465×Heat of fusion+3.5988

### Example 6

### Determining the Crystallinity of Samples Containing Varying Amounts of Crystalline CCI-779

This example was performed to determine the accuracy of the equation set forth in Example 4. Specifically, the heats of fusion for four (4) samples containing known amounts of crystalline CCI-779 were determined. Once determined, the crystallinities were calculated using the equation in Example 4. The results are shown in Table 5.

TABLE 5

| Crystal | Total | Actual | Onset T | Peak T | Heat of fusion | Calculated | Error |
|---|---|---|---|---|---|---|---|
| (mg) | weight (mg) | Crystallinity (%) | (° C.) | (° C.) | (J/g) | Crystallinity (%) | (%) |
| 2.4 | 5.1 | 47.0 | 154.17 | 165.23 | 26.4 | 47.1 | −0.14 |
| 3.1 | 4 | 77.5 | 159.18 | 167.08 | 43.96 | 76.0 | 1.96 |
| 5.3 | 6.8 | 77.9 | 159.03 | 166.74 | 43.81 | 75.7 | 2.78 |
| 3.9 | 4.3 | 90.1 | 160.52 | 167.75 | 51.46 | 88.3 | 1.97 |

These data illustrate that by using the heat of fusion, the crystallinity can accurately be calculated with less than a 3% error.

### Example 7

### Effect of Sample Weight on Heat of Fusion

In this example, the effect of sample weight in determining the crystallinity of three samples of CCI-779 was measured.

Samples 1 and 2 were obtained by crystallizing CCI-779 from ether/heptane using the procedure set forth in U.S. Provisional Patent Application No. 60/748,006.

Sample 3 was obtained using the procedure set forth in U.S. Provisional Patent Application No. 60/748,143.

The samples were analyzed for the DSC onset temperatures, peak temperatures, and heat of fusion values using the Q Series™ Q1000-0450 DSC Instrument (TA Instruments) using the parameters set forth in Table 2. The results are provided in Tables 6-8.

TABLE 6
Sample 1

| Sample Weight | Onset T | Peak T | Heat of Fusion |
|---|---|---|---|
| (mg) | (° C.) | (° C.) | (J/g) |
| 2.4 | 163.47 | 169.29 | 59.84 |
| 3 | 163.12 | 169.13 | 59.34 |
| 5.1 | 163.07 | 169.23 | 58.81 |
| Average | 163.22 | 169.22 | 59.33 |
| Standard Deviation | 0.18 | 0.07 | 0.42 |
| Coefficient of Variation | 0.001 | 0.0004 | 0.007 |

TABLE 7
Sample 2

| Sample Weight | Onset T | Peak T | Heat of Fusion |
|---|---|---|---|
| (mg) | (° C.) | (° C.) | (J/g) |
| 5.1 | 151.13 | 164.63 | 49.11 |
| 3.5 | 151.4 | 164.83 | 51.91 |
| 5.1 | 151.03 | 164.83 | 49.59 |
| 8.9 | 151.03 | 164.5 | 48.49 |
| Average | 151.04 | 164.5 | 49.29 |
| Standard Deviation | 0.37 | 164.6975 | 1.49 |
| Coefficient of Variation | 0.002 | 0.00082 | 0.030 |

TABLE 8
Sample 3

| Sample Weight | Onset T | Peak T | Heat of Fusion |
|---|---|---|---|
| (mg) | (° C.) | (° C.) | (J/g) |
| 6.7 | 157.69 | 165.72 | 53.41 |
| 12.8 | 157.19 | 166.48 | 51.85 |
| 4.8 | 157.87 | 165.75 | 54.21 |
| 3.8 | 157.87 | 165.73 | 54.45 |
| 6.8 | 157.58 | 165.52 | 54.84 |
| 4.2 | 158 | 165.92 | 54.12 |
| Average | 157.7 | 165.85 | 53.81 |
| Standard Deviation | 0.265 | 0.303 | 0.98 |
| Coefficient of Variation | 0.0016825 | 0.001829 | 0.018 |

By using the average heat of fusion set forth in Tables 6-8 provided above, the degree of crystallinity of each batch was calculated using the equation set forth in Example 3. The results are provided in Table 9.

TABLE 9

| | Degree of |
|---|---|
| Batch | Crystallinity (%) |
| 1 | 101 |
| 2 | 85 |
| 3 | 92 |

These data illustrate that sample weight does not substantially affect the crystallinity of a sample or the use of a heat of fusion in predicting the crystallinity of a sample containing CCI-779.

### Example 8

### Determining the Crystallinity of Samples Containing CCI-779

Nineteen (19) samples containing crystalline CCI-779 were prepared and analyzed using the DSC parameters set forth in Table 2. The crystallinity of each sample was calculated using the average heat of fusion obtained for each sample using DSC and equation in Example 6 and reproduced below. The results are provided in Table 10.
Degree of crystallinity=1.6465×Heat of Fusion+3.5988

TABLE 10

| | | | | | Crystal- |
|---|---|---|---|---|---|
| | Sample | Onset T | Peak T | Heat of | linity |
| Sample | weight (mg) | (° C.) | (° C.) | fusion (J/g) | (%) |
| 1 | 4.52 | 152.8 | 163.19 | 42.29 | 73 |
| 2 | 4.03 | 160.16 | 168.36 | 43.46 | 75 |
| 3 | 3.9 | 154.23 | 163.75 | 44.4 | 77 |
| 4 | 2.99 | 160.65 | 168.16 | 46.55 | 80 |
| 5 | 3.63 | 163.3 | 174.75 | 47.19 | 81 |
| 6 | 3.64 | 161.84 | 174 | 47.29 | 81 |
| 7 | 4.13 | 157.05 | 171.08 | 49.21 | 85 |
| 8 | 3.53 | 158.66 | 166.19 | 49.25 | 85 |
| 9 | 4.43 | 161.08 | 168.34 | 52.96 | 91 |
| 10 | 2.29 | 163.06 | 172.05 | 53.52 | 92 |
| 11 | 3.37 | 162.28 | 170.28 | 53.96 | 92 |
| 12 | 3.81 | 162.12 | 169.41 | 54.95 | 94 |
| 13 | 3.22 | 162.73 | 171.61 | 55.14 | 94 |
| 14 | 3.9 | 164.92 | 175.81 | 55.92 | 96 |
| 15 | 3.44 | 164.7 | 172.87 | 56.22 | 96 |
| 16 | 4.03 | 162.93 | 170.75 | 56.62 | 97 |
| 17 | 3.41 | 164.36 | 171.65 | 57.12 | 98 |
| 18 | 3.51 | 167.41 | 175.89 | 57.15 | 98 |
| 19 | 4.86 | 161.73 | 171.08 | 57.36 | 98 |

The stability of the samples was then separately analyzed after a period of 6 months at (i) 5° C. or (ii) 25° C. at 60% relative humidity. The results indicate that batches having a higher content of crystalline CCI-779 were more stable than samples containing a lower content of crystalline CCI-779.

### Example 9

### Variation of Heating Rate on Heat of Fusion and Crystallinity

Six samples containing crystalline CCI-779 were analyzed by DSC using the parameters set forth in Table 2. Samples 1, 4, and 7 contained 7 mg of crystalline CCI-779 and were heated in the DSC at a temperature of 7° C./min. Samples 2, 5, and 8 contained 10 mg of crystalline CCI-779 and were heated in the DSC at a rate of 10° C./min. Samples 3, 6, and 9 contained 20 mg of crystalline CCI-779 and were heated in the DSC at a rate of 20° C./min. The onset temperature, peak temperature, and heat of fusion were obtained from the DSC and are provided in Table 11.

TABLE 11

| | Heating | Sample | | | Heat of | Crystal- |
|---|---|---|---|---|---|---|
| | Rate | weight | Onset T | Peak T | fusion | linity |
| Sample | (° C./min) | (mg) | (° C.) | (° C.) | (J/g) | (%) |
| 1 | 7 | 7 | 155.35 | 161.14 | 48.19 | 83 |
| 2 | 10 | 10 | 155.66 | 166.47 | 50.18 | 86 |
| 3 | 20 | 20 | 157.43 | 164.22 | 49.86 | 86 |
| 4 | 7 | 7 | 156.54 | 162.77 | 44.29 | 77 |
| 5 | 10 | 10 | 160.09 | 168.36 | 44.26 | 76 |
| 6 | 20 | 20 | 159.27 | 166.18 | 45.51 | 79 |
| 7 | 7 | 7 | 160.51 | 165.48 | 58.68 | 100 |
| 8 | 10 | 10 | 164.37 | 171.65 | 57.25 | 98 |
| 9 | 20 | 20 | 162.69 | 169.2 | 58.93 | 101 |

The data illustrated that increasing the heating rate during analyzation by DSC did not significantly alter the heat of fusion.

All publications cited in this specification are incorporated herein by reference herein. While the invention has been described with reference to a particularly preferred embodiment, it will be appreciated that modifications can be made without departing from the spirit of the invention. Such modifications are intended to fall within the scope of the appended claims.

What is claimed is:

1. A method for measuring particle quality of a rapamycin compound using differential scanning calorimetry, comprising:
analyzing the heat flow signal of a sample comprising a rapamycin compound; and
comparing the heat flow signal of said sample to the heat flow signal of a predetermined standard;
wherein said particle quality is proportional to the melting temperature of said heat flow signal of said sample.

2. The method according to claim 1, wherein a higher melting temperature corresponds to a higher quality particle.

3. The method according to claim 2, wherein a higher particle quality corresponds to a higher crystallinity of said rapamycin compound.

4. The method according to claim 1, wherein said melting temperature is proportional to the median particle size of the crystals of said rapamycin compound.

5. The method according to claim 4, wherein a large median particle size is characterized by a high melting temperature.

6. The method according to claim 5, wherein said sample comprises CCI-779 and said large median particle size is at least about 30 μm.

7. The method according to claim 6, wherein said large median particle size is about 30 μm to about 250 μm.

8. The method according to claim 5, wherein said sample comprises CCI-779 and said high melting temperature is at least about 168° C.

9. The method according to claim 8, wherein said high melting temperature is about 168 to about 170° C.

10. The method according to claim 5, wherein said sample comprises rapamycin and said high melting temperature is at least about 188° C.

11. The method according to claim 10, wherein said high melting temperature is about 188° C. to about 190° C.

12. The method according to claim 1, wherein a small median particle size of the crystals of said rapamycin compound is characterized by a low melting temperature.

13. The method according to claim 12, wherein said sample comprises CCI-779 and said small median particle size is less than about 30 μm.

14. The method according to claim 1, wherein a lower melting temperature corresponds to a lower quality particle.

15. The method according to claim 14, wherein a lower particle quality corresponds to a lower crystallinity.

16. The method according to claim 14, wherein said sample comprises CCI-779 and said low melting temperature is less than about 166° C.

17. The method according to claim 16, wherein said low melting temperature is about 164 to about 166° C.

18. The method according to claim 14, wherein said sample comprises rapamycin and said low melting temperature is less than about 183° C.

19. The method according to claim 14, wherein said sample comprises rapamycin and said low melting temperature is less than about 180 to about 183° C.

20. The method according to claim 1, wherein said sample comprises semi-crystalline aggregates and has a lower melting temperature than a crystalline sample.

21. The method according to claim 1, wherein said sample comprises a non-crystalline rapamycin compound and has a lower melting temperature than a sample comprising a semi-crystalline rapamycin compound.

22. The method according to claim 1, wherein said sample comprising a non-crystalline rapamycin compound and has a lower melting temperature than a sample comprising a crystalline rapamycin compound.

23. The method according to claim 1, wherein said rapamycin compound is purified from the same solvent as the predetermined standard.

24. The method according to claim 1, wherein said sample comprises rapamycin.

25. The method according to claim 1, wherein said sample comprises CCI-779.

26. A method for determining median particle size of a sample containing crystals of a rapamycin compound using differential scanning calorimetry, comprising:
analyzing the melting temperature of a sample comprising a rapamycin compound; and
comparing the melting temperature to a predetermined standard;
wherein said median particle size is proportional to the melting temperature of said sample.

27. The method according to claim 26, wherein a large median particle size is characterized by a high melting temperature and a small median particle size is characterized to a low melting temperature.

28. A method for determining the crystallinity of a rapamycin compound, comprising:
analyzing the heat flow signal of a test sample comprising a raparnycin compound; and
calculating the crystallinity of said test sample by comparing said heat flow signal to the heat flow signal of a predetermined standard comprising a crystalline rapamycin compound.

29. The method according to claim 28, wherein said calculation is performed using a single point calculation.

30. The method according to claim 29, wherein said predetermined standard comprises a 100% crystalline rapamycin compound.

31. The method according to claim 30, wherein said crystallinity of said test sample is calculated according to the following:
test sample crystallinity=100×heat of fusion of said test sample/heat of fusion of said predetermined standard.

32. The method according to claim 28, wherein said calculation is performed using a calibration curve.

33. The method according to claim 32, wherein said predetermined standard comprises multiple samples comprising crystalline rapamycin compound.

34. The method according to claim 33, further comprising:
plotting the heat of fusion, peak temperature, or onset temperature for each of said multiple samples against the crystallinity of each of said multiple samples to obtain a calibration curve having a best fit line;
calculating a formula of said best fit line;
analyzing the heat of fusion, peak temperature, or onset temperature of said rapamycin compound in said test sample; and
calculating the crystallinity of said rapamycin compound in said test sample using said heat of fusion, peak temperature, or onset temperature of said test sample and said formula.

35. The method according to claim 33, wherein said calibration curve is prepared by plotting said heat of fusion for each of multiple samples comprising a crystalline rapamycin compound of a known crystallinity against the crystallinity for each of multiple samples comprising said rapamycin compound.

36. A method for purifying rapamycin, comprising:
(i) heating crude rapamycin in ethyl acetate to about 55° C.;
(ii) filtering the product of step (i);
(iii) maintaining the temperature of step (ii) at about 54° C. to about 57° C.;
(iv) adding heptanes to the product of step (iii) over a period of about 60 minutes at a constant rate;
(v) maintaining the product of step (iv) at said temperature for about 30 minutes;
(vi) reducing the agitation speed of step (v);
(vii) cooling the product of step (vi) to about 40° C. at a rate of about 5° C./hour;
(viii) cooling the product of step (vii) to a temperature of about 25° C. at a rate of about 7.5° C./hour;
(ix) cooling the product of step (viii) to a temperature of about 7 to 8° C. at a rate of at least about 9° C./hour;
(x) maintaining the product of step (ix) at said temperature for about 2 hours; and
(xi) filtering the product of step (x) to obtain said crystalline rapamycin.

37. The method according to claim 36, further comprising:
(xii) washing said crystalline rapamycin with ethyl acetate and heptane at about 8° C.; and
(xiii) drying the product of step (xii).
